(19) United States
(12) Patent Application Publication
(10) Pub. No.: US 2026/0195882 A1
(43) Pub. Date: Jul. 9, 2026

(54) INSPECTION DEVICE, INSPECTION SYSTEM, INSPECTION METHOD, AND RECORDING MEDIUM

(71) Applicant: Mitsubishi Electric Corporation, Tokyo (JP)

(72) Inventors: Kotoko MIYATA, Tokyo (JP); Shinichiro NISHIUMA, Tokyo (JP)

(73) Assignee: Mitsubishi Electric Corporation, Tokyo (JP)

(21) Appl. No.: 19/129,309

(22) PCT Filed: Jun. 28, 2023
(86) PCT No.: PCT/JP2023/024041

§ 371 Date: May 13, 2025

(51) Int. Cl. G06T 7/00

(52) U.S. Cl. CPC G06T 7/0004; G06T 2207/30108

(57) ABSTRACT

The inspection device includes a task setter that configures a setting of an inspection task including a processing blocks indicating a process related to inspection, a task executer that, when the inspection task includes a plurality of the processing blocks, sequentially executes the plurality of processing blocks and holds, for each inspection task, some or all of data output by each processing block of the plurality of processing blocks, and a data storage that stores, in a file server for each inspection task, the data held by the task executer for each inspection task. The inspection device enables collective management of various types of data related to inspection.

### TECHNICAL FIELD

The present disclosure relates to an inspection device, an inspection system, an inspection method, and a program.

### BACKGROUND ART

Automation of inspection through the use of image processing, machine learning, and related technologies is becoming increasingly important in the manufacturing industry. In the automation of inspection, there is a need for a technology to collectively manage various types of data related to inspection, such as captured image data of manufactured products, inspection results, abnormalities, date and time, and values obtained from a control device.

Patent Literature 1 discloses a technology for collectively managing various types of data related to inspection by individually storing the various types of data related to inspection and associating the individually stored data.

### CITATION LIST

### Patent Literature

Patent Literature 1: Unexamined Japanese Patent Application Publication No. 2014-174701

### SUMMARY OF INVENTION

### Technical Problem

Since the technology of Patent Literature 1 is to individually store data and then perform an additional process to associate the data, problems may arise. For example, data association may fail due to errors occurring in the additional process, or data obtained in one inspection may be mistakenly associated with data obtained in another inspection.

In response to the above circumstances, an objective of the present disclosure is to provide an inspection device and others that can more appropriately associate various types of data related to inspection.

### Solution to Problem

To achieve the above objective, an inspection device according to the present disclosure includes:
task setting means for configuring a setting of an inspection task including a processing block, the processing block indicating a process related to inspection;
task execution means for, when the inspection task includes a plurality of the processing blocks, sequentially executing the plurality of processing blocks and holding, for each inspection task set by the task setting means, some or all of data output by each processing block of the plurality of processing blocks; and
data storage means for storing, in storage means for each inspection task, the data held by the task execution means for each inspection task.

### Advantageous Effects of Invention

The present disclosure can more appropriately associate various types of data related to inspection.

### BRIEF DESCRIPTION OF DRAWINGS

FIG. 1 illustrates an overall configuration of an inspection system according to an embodiment of the present disclosure;

FIG. 2 illustrates a network configuration of the inspection system according to the embodiment of the present disclosure;

FIG. 3 illustrates an exemplary task setting screen displayed on a terminal device according to the embodiment of the present disclosure;

FIG. 4 illustrates an exemplary monitor screen displayed on the terminal device according to the embodiment of the present disclosure;

FIG. 5 illustrates an exemplary monitor screen displayed on the terminal device according to the embodiment of the present disclosure;

FIG. 6 illustrates an exemplary monitor screen displayed on the terminal device according to the embodiment of the present disclosure;

FIG. 7 is a block diagram illustrating a functional configuration of an inspection device according to the embodiment of the present disclosure;

FIG. 8 illustrates exemplary association information stored in the inspection device according to the embodiment of the present disclosure;

FIG. 9 is a block diagram illustrating a functional configuration of the terminal device according to the embodiment of the present disclosure;

FIG. 10 illustrates exemplary hardware configurations of the inspection device and the terminal device according to the embodiment of the present disclosure;

FIG. 11 is a flowchart of exemplary data storage operations performed by the inspection device according to the embodiment of the present disclosure; and

FIG. 12 is a flowchart of exemplary layout generation operations performed by the inspection device according to the embodiment of the present disclosure.

### DESCRIPTION OF EMBODIMENTS

Hereinafter, an inspection system according to an embodiment of the present disclosure is described with reference to the drawings. In the drawings, the same reference sign is assigned to the same or equivalent parts.

### Embodiment

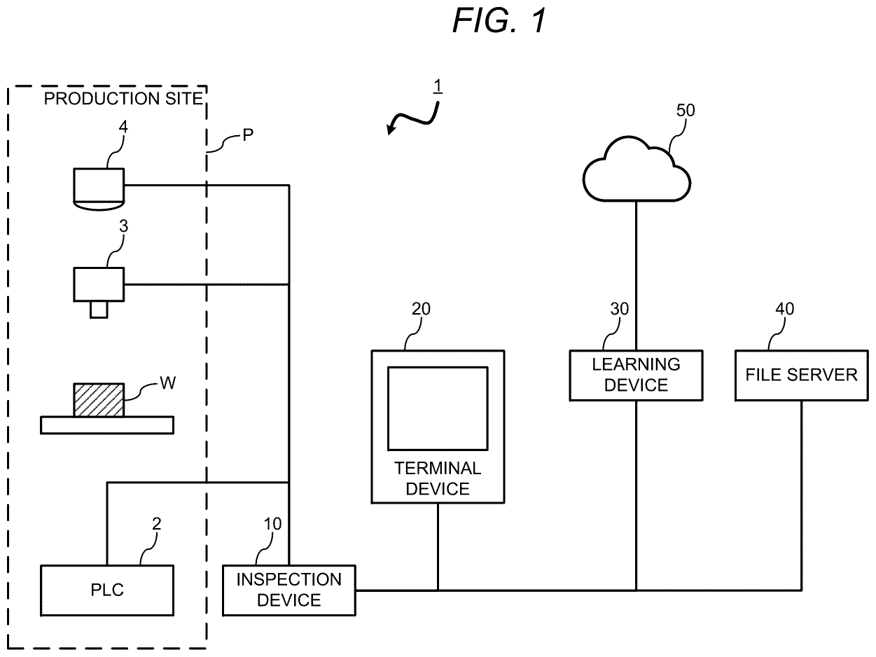

An inspection system 1 according to the embodiment is described with reference to FIG. 1. The inspection system 1 is an inspection system that inspects, based on captured images and learned models, a workpiece W that is a manufactured product to be processed at a production site P. The inspection system 1 includes an inspection device 10, a terminal device 20, a learning device 30, a file server 40, a cloud system 50, a programmable logic controller (PLC) 2, a camera 3, and a light 4. The PLC 2, the camera 3, and the light 4 are installed at the production site P. At the production site P, a conveyor belt, a robot arm, and related machinery, which are not illustrated, may be installed to move the workpiece W. Although FIG. 1 illustrates solely one inspection device, the inspection system 1 may include multiple inspection devices. The inspection system 1 is an example of an inspection system according to the present disclosure. The PLC 2 is an example of a programmable logic controller according to the present disclosure. The camera 3 is an example of an imaging device according to the present disclosure.

The inspection device 10 executes various tasks related to inspection. Hereinafter, the tasks related to inspection are simply referred to as inspection tasks. The inspection tasks are a series of processes such as receiving an instruction to start inspection, capturing images of an inspection target by the camera 3, performing inspection based on the captured images, and providing feedback of inspection results to a user. The inspection tasks include one or more processes related to inspection, and these processes are, for example, capturing images of the workpiece W by the camera 3, configuring settings of the light 4 required in the image capturing, acquiring a device value of the PLC 2 at inspection of the workpiece W, inspecting the workpiece W based on the captured images and learned models, and other related processes. The learned models are stored in the inspection device 10 or the learning device 30. The learned models may be additionally stored in the file server 40. The inspection device 10 stores, in the file server 40 for each of the inspection tasks, various types of data obtained in execution of the inspection tasks. This allows the inspection device 10 to easily associate various types of data related to inspection. Each of the inspection tasks is a single unit that is the series of processes from instruction to start inspection to feedback of inspection results. The inspection device 10 transmits, to the terminal device 20, monitor layout information for display of information of the inspection tasks on the terminal device 20. The inspection device 10 is described in detail later. The inspection device 10 is an example of an inspection device according to the present disclosure.

The terminal device 20 is a terminal device that includes an input unit and a display. The terminal device 20 is used by a user to configure settings related to the inspection tasks of the inspection device 10 and to monitor information related to execution of the inspection tasks by the inspection device 10. The terminal device 20 uses the same user interface for settings related to generation of the learned models, settings of the PLC 2, settings of the camera 3, settings of the light 4, and other settings. This can reduce the workload of the user when configuring settings of the inspection system 1. The terminal device 20 is, for example, a personal computer, a tablet terminal, or equivalent devices. The terminal device 20 is described in detail later. The terminal device 20 is an example of a terminal device according to the present disclosure.

The learning device 30 generates the learned models for inspection of the workpiece W through machine learning based on captured image data that is data of the captured images of the workpiece W captured by the camera 3. The learned models are stored in the inspection device 10 or the learning device 30 itself. The learning device 30 downloads templates, frameworks, libraries, and other related resources for use in the machine learning from the cloud system 50. The user operates the terminal device 20 to select a template, a framework, a library, and other related resources to be used by the learning device 30.

The file server 40 stores the various types of data obtained by the inspection device 10 in execution of the inspection tasks. The file server 40 stores the learned models generated by the learning device 30.

The cloud system 50 provides the templates, frameworks, libraries, and other related resources for use in the machine learning.

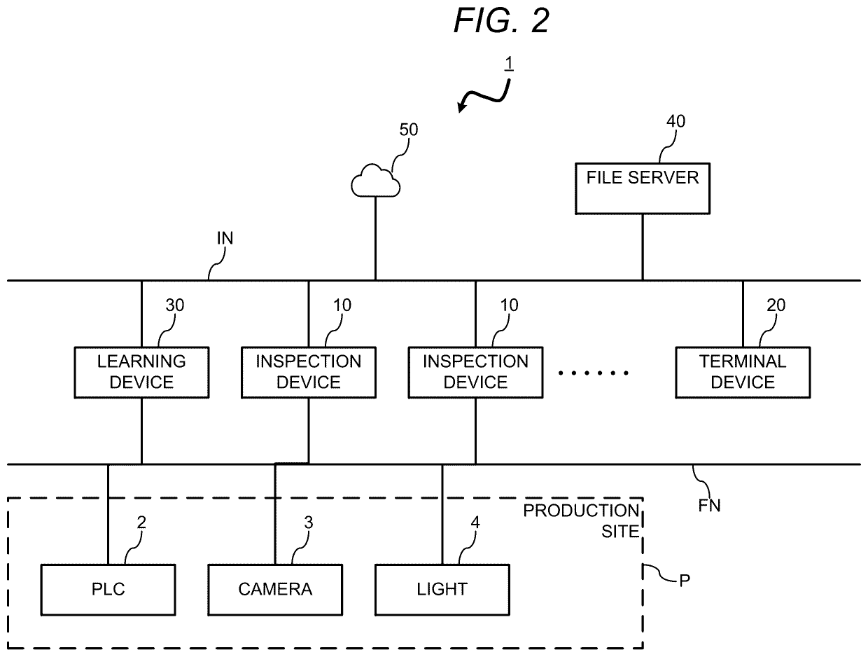

A network configuration of the inspection system 1 is described with reference to FIG. 2. The inspection system 1 includes a factory network FN and an information network IN. Both the learning device 30 and the inspection device 10 are connected to both the factory network FN and the information network IN. The PLC 2, the camera 3, and the light 4 installed at the production site P are connected to the factory network FN. The terminal device 20, the file server 40, and the cloud system 50 are connected to the information network IN.

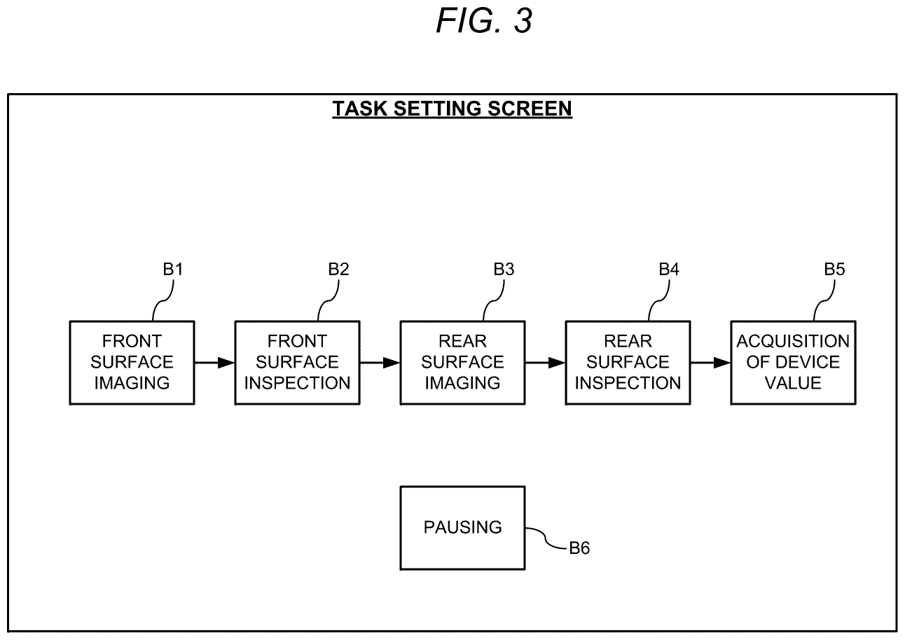

Configuration of the settings of the inspection task and display of information related to the inspection tasks performed by the terminal device 20 are schematically described with reference to FIGS. 3 to 6.

The user operates the terminal device 20 to call a task setting screen illustrated in FIG. 3. In the task setting screen, one or more processing blocks B1 to B6 (hereinafter, also collectively referred to as the “processing blocks B”) may be combined to form one inspection task. The processing blocks B, in principle, have a sequence or a flow as in the processing blocks B1 to B5, but also include a processing block that does not have such a sequence, such as the processing block B6.

The processing block B6 (hereinafter, also referred to as the “pausing block B6”) that is a processing block related to pausing (hereinafter referred to as the “pausing block”) is used to pause tasks being executed in response to user operation. When the inspection tasks include the pausing block B6, the user can pause these inspection tasks. The pausing block B6 may also be used to resume tasks that has already been paused. Such task resumption includes not only resumption of tasks paused by the pausing block B6, but also resumption of tasks paused for any other reasons. Processes for pausing and resuming a task are described later. As described above, the processing blocks B include a processing block that executes processes based on user operation (hereinafter, also referred to as the “operation block”).

Each processing block B, in principle, performs some output. For example, the processing blocks B1 and B3 that are processing blocks for image capturing output data of captured images. The processing blocks B2 and B4 that are processing blocks for inspection output data of inspection results. The processing block B5 that is a processing block for acquisition of a device value outputs data of an acquired device value. In addition, each processing block B may process and output data output by another processing block B. For example, there may be a processing block B that preprocesses the data of captured images and outputs the preprocessed image data. This processing block for preprocessing is provided between the processing block for image capturing and the processing block for inspection in the flow of an inspection task. Between the processing block for image capturing and the processing block for inspection, processing blocks for data computation, generation of new images, and other related processes may be provided, in addition to the processing block for preprocessing.

The inspection device 10 stores, based on the inspection tasks selected by the user, data output by each of the processing blocks in the file server 40 for each of the inspection tasks. Although not illustrated in FIG. 3, the user may configure, in the task setting screen, a setting to store solely a portion of the data output by each of the processing blocks. For example, the user may select the type of data to be stored from the data output by each of the processing blocks. In another example, the user may select data to be stored separately for each of the processing block.

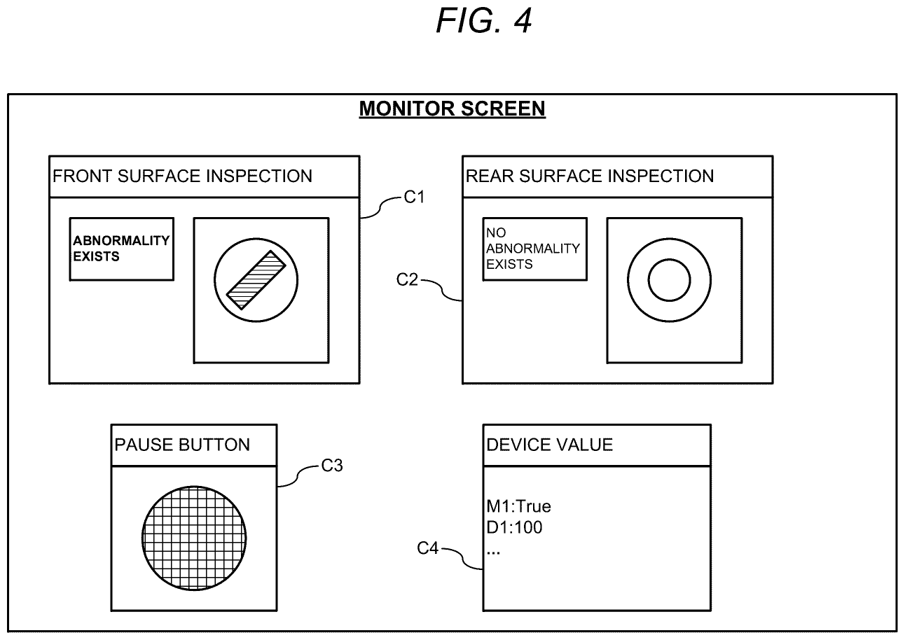

After configuring settings of the inspection tasks, the user can call a monitor screen illustrated in FIG. 4 by operating the terminal device 20. The monitor screen illustrated in FIG. 4 is displayed based on the monitor layout information generated by the inspection device 10. The monitor screen illustrated in FIG. 4 includes monitor components C1 to C4 (hereinafter, also collectively referred to as the “monitor components C”). The monitor component C1 that is related to front surface inspection corresponds to the processing block B2 for front surface inspection illustrated in FIG. 3. The monitor component C2 that is related to rear surface inspection corresponds to the processing block B4 for rear surface inspection illustrated in FIG. 3. The monitor component C3 that is related to a pause button (hereinafter, also referred to as the “pause button C3”) corresponds to the pausing block B6 illustrated in FIG. 3. The monitor component C4 that is related to a device value corresponds to the processing block B5 for acquisition of a device value illustrated in FIG. 3. In FIG. 4, based on display item settings described below, the monitor component corresponding to the processing block B1 for front surface imaging and the monitor component corresponding to the processing block B3 for rear surface imaging are not displayed.

As described above, the layout of the monitor screen is generated by a combination of the monitor components C so as to display information of each of the processing blocks B included in the inspection tasks side by side in accordance with the settings of the inspection tasks configured in the task setting screen. This allows the user to review inspection conditions in the monitor screen suitable for the inspection tasks selected by the user, and thus facilitates review of the inspection conditions.

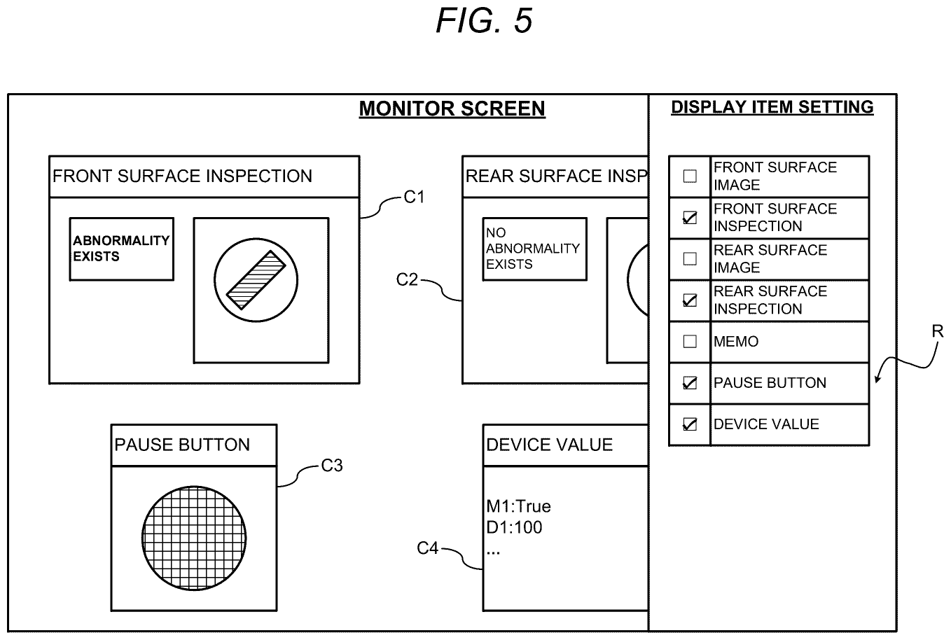

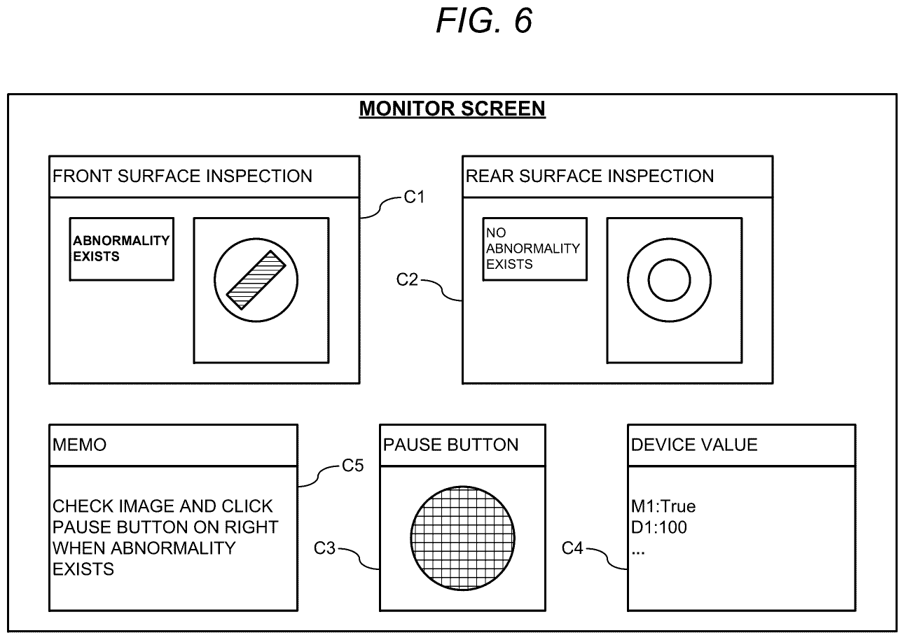

The user can also select the monitor components to be displayed from a display item setting region R as illustrated in FIG. 5 by operating the terminal device 20. For example, when the item “memo” is checked, the monitor component C5 that is related to memos is added to the monitor screen as illustrated in FIG. 6. This monitor component C5 for the item “memo” is a monitor component for a user to freely enter text. Unlike the monitor components C1 to C4, the monitor component C5 for the item “memo” is not associated with the processing blocks B. As described above, the monitor components include a monitor that is not associated with the processing blocks B but is provided for the convenience of a user.

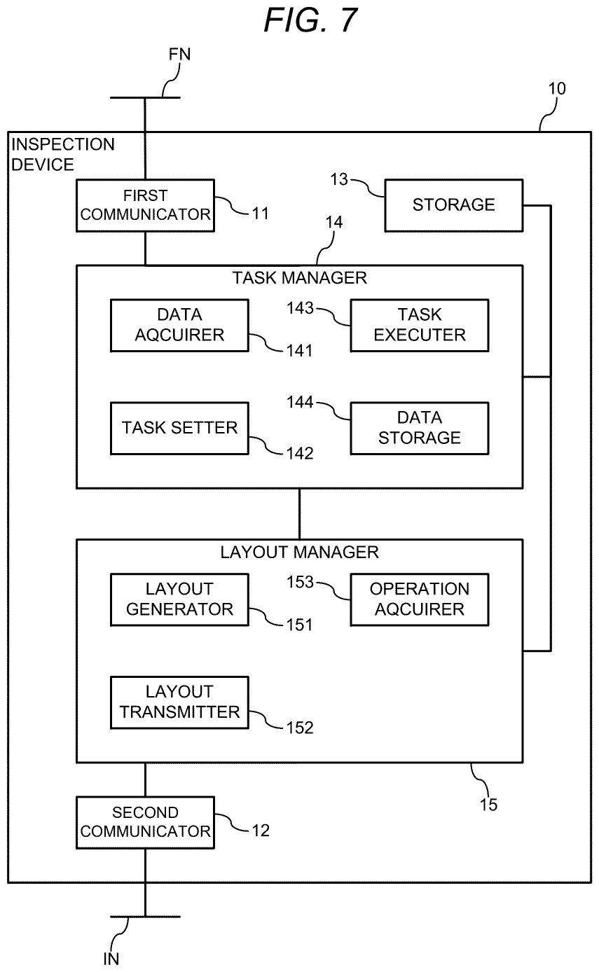

A functional configuration of the inspection device 10 is described with reference to FIG. 7. The inspection device 10 includes a first communicator 11, a second communicator 12, a storage 13, a task manager 14, and a layout manager 15.

The first communicator 11 communicates with each of the devices connected to the factory network FN.

The second communicator 12 communicates with each of the devices connected to the information network IN.

The storage 13 stores task setting information that indicates settings of the inspection tasks, association information that indicates association between the processing blocks B and the monitor components C, and layout setting information that is information of settings of the layout of the monitor screen. The storage 13 is an example of storage means according to the present disclosure.

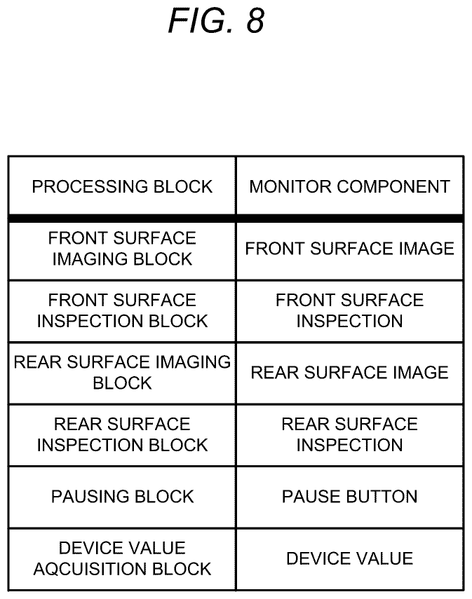

The task setting information includes information of the processing blocks B included in the inspection tasks, information related to the flow between the processing blocks B included in the inspection tasks, information of data to be stored selected by the user, and other related information. The association information is represented by, for example, a table illustrated in FIG. 8. The association information enables identification of the monitor component C corresponding to the processing block B indicated by the task setting information. The association information is prepared in advance by, for example, a manufacturer of the inspection device 10 and stored in the storage 13. The layout setting information includes information indicating the monitor component C to be displayed and the display position of the monitor component to be displayed. The layout setting information is determined based on, for example, the above-described user operation in the display item setting region R illustrated in FIG. 5.

The task manager 14 manages the inspection tasks. The task manager 14 includes a data acquirer 141, a task setter 142, a task executer 143, and a data storage 144.

The data acquirer 141 acquires a device value from the PLC 2 via the first communicator 11, and acquires, from the camera 3 via the first communicator 11, the captured image data that is data of the captured images of the workpiece W. This data acquisition may be performed as one of the processes in the processing block executed by the task executer 143 described later. The data acquirer 141 is an example of data acquisition means according to the present disclosure.

The task setter 142 configures the settings of the inspection tasks based on user operation via the task setting screen displayed by the terminal device 20. As described later, the terminal device 20 transmits, to the inspection device 10, information based on the user operation via the task setting screen. The task setter 142 acquires this information via the second communicator 12, and configures the settings of the inspection tasks based on this information. The task setter 142 stores, in the storage 13, the task setting information that indicates settings of the inspection tasks. The configuration in which the user operates the terminal device 20 to select data to be stored and the task setter 142 configures settings of the data to be stored when configuring the settings of the inspection tasks enables storage of the data selected by the user for each of the inspection tasks. The task setter 142 is an example of task setting means according to the present disclosure.

The task executer 143 refers to the task setting information stored in the storage 13, sequentially executes the multiple processing blocks B included in the inspection tasks, and holds, for each of the inspection tasks, data to be stored selected by the user from the data output by each of the processing blocks B. The task executer 143 also holds the referred task setting information for each of the inspection tasks. When the user operates the terminal device 20 to operate the monitor component C corresponding to the operation block, the task executer 143 executes processes in the corresponding operation block. For example, when the operation block is the pausing block B6 and the inspection tasks are not paused, the task executer 143 pauses execution of the inspection tasks. When the inspection tasks are paused, the task executer 143 resumes execution of the paused tasks. The task executer 143 is an example of task execution means according to the present disclosure.

The data storage 144 stores, in the file server 40 via the second communicator 12, the data held by the task executer 143 for each of the inspection tasks. For example, the data storage 144 stores the data when the task executer 143 completes execution of each of the inspection tasks. As a result, various types of data related to inspection are automatically associated for each of the inspection tasks. Since the task executer 143 also holds the task setting information for each of the inspection tasks, the task setting information is stored in the file server 40 for each of the inspection tasks. Thus, the user can refer to the various types of data and the task setting information stored in the file server 40 for each of the inspection tasks to reproduce and verify the inspection tasks as appropriate. The data storage 144 is an example of data storage means according to the present disclosure.

The layout manager 15 manages the layout of the monitor screen displayed on the terminal device 20. The layout manager 15 includes a layout generator 151, a layout transmitter 152, and an operation acquirer 153.

The layout generator 151 refers to the task setting information, the association information, and the layout setting information stored in the storage 13, and generates the monitor layout information for generation of, for example, the monitor screen illustrated in FIG. 4. The monitor layout setting information includes information of the display position of each of the monitor components C, information of the item to be displayed on each of the monitor components C, and other related information. Most of the monitor components C are those for display related to output of the processing blocks B, and the layout generator 151 thus refers to the data held by the task executer 143 for each of the inspection tasks as appropriate. The monitor layout information is represented as Web content, such as hypertext markup language (HTML) files, image files, and similar resources.

When the user performs an operation for change of layout settings, for example, an operation in the display item setting region R illustrated in FIG. 5, the layout generator 151 stores new layout setting information in the storage 13, and generates new monitor layout information based on the new layout setting information. The operation for change of layout settings is acquired by the operation acquirer 153 described later.

The layout transmitter 152 transmits, via the second communicator 12 to the terminal device 20, the monitor layout information generated by the layout generator 151. For example, as described above, when the monitor layout information is represented as Web content, the layout transmitter 152 is implemented by incorporating functions of a Web server.

The operation acquirer 153 acquires, from the terminal device 20 via the second communicator 12, information indicating the operation for change of layout settings by the user. For example, when the user operates the display item setting region R illustrated in FIG. 5 to turn on the item “memo”, the terminal device 20 transmits this information of the operation to the inspection device 10, and the operation acquirer 153 acquires this information of the operation. The layout generator 151 stores, in the storage 13 based on this information of the operation acquired by the operation acquirer 153, new layout setting information indicating that the monitor component C for the item “memo” is to be displayed. The layout generator 151 then generates new monitor layout information including the monitor component C for the item “memo”.

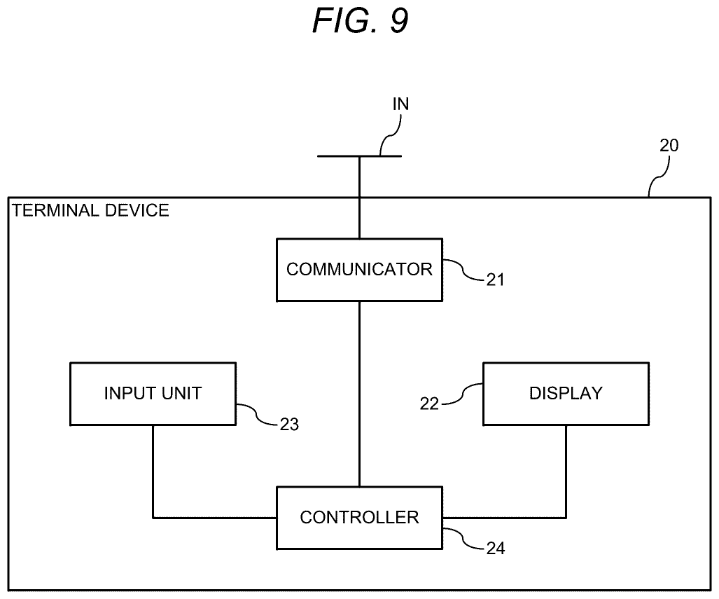

A functional configuration of the terminal device 20 is described below with reference to FIG. 9. The terminal device 20 includes a communicator 21, a display 22, an input unit 23, and a controller 24.

The communicator 21 communicates with each of the devices connected to the information network IN.

The display 22 displays a screen under the control of the controller 24. The display 22 is, for example, a liquid crystal display. The display 22 may be a touchscreen integral with the input unit 23 described later.

The input unit 23 receives user operation, and outputs a signal indicating the user operation to the controller 24. The input unit 23 includes, for example, an input device such as a mouse, a keyboard, and other related devices. In another example, the input unit 23 may be a touchscreen integral with the display 22 described later. The input unit 23 is an example of input means according to the present disclosure.

The controller 24 performs overall control of the terminal device 20. In particular, the controller 24 acquires the monitor layout information from the inspection device 10 via the communicator 21, and controls the display 22 to display the monitor screen based on the monitor layout information. When the user calls the task setting screen through operations on the input unit 23 to configure task settings, the controller 24 transmits information indicating the task settings to the inspection device 10. When the user operates, in the monitor screen through the operations on the input unit 23, the monitor component C corresponding to the operation block, the controller 24 transmits information indicating this operation to the inspection device 10. When the user operates, through the operations on the input unit 23, display item settings of the monitor component C to be displayed in the monitor screen, the controller 24 transmits information indicating the selected display items to the inspection device 10.

The controller 24 controls the display 22 to display, as setting screens that can be operated by the same user interface, a setting screen for model generation by the learning device 30, a setting screen for the PLC 2, a setting screen for the camera 3, and a setting screen for the light 4. The controller 24 can configure settings of the PLC 2, the camera 3, and the light 4 via the inspection device 10 or the learning device 30. The controller 24 configures settings of the learning device 30, the PLC 2, the camera 3, and the light 4 based on user operation via the above-described setting screens.

The controller 24 functions as, for example, a Web browser. The controller 24 that functions as a Web browser communicates with the inspection device 10 or the learning device 30 that functions as a Web application server, and acquires Web content indicating various setting screens from the inspection device 10 or the learning device 30. The controller 24 controls the display 22 to display a setting screen based on the acquired Web content. For example, the configuration in which Web content indicating various setting screens is generated by the same Web framework allows the inspection device 10 or the learning device 30 that functions as a Web application server to implement the various setting screens that can be operated by the same user interface. The controller 24 transmits information indicating user operation on each of the various setting screens to the inspection device 10 or the learning device 30 that functions as a Web application server. The inspection device 10 or the learning device 30 that has received this information configures the settings of the PLC 2, the camera 3, and the light 4 based on this information.

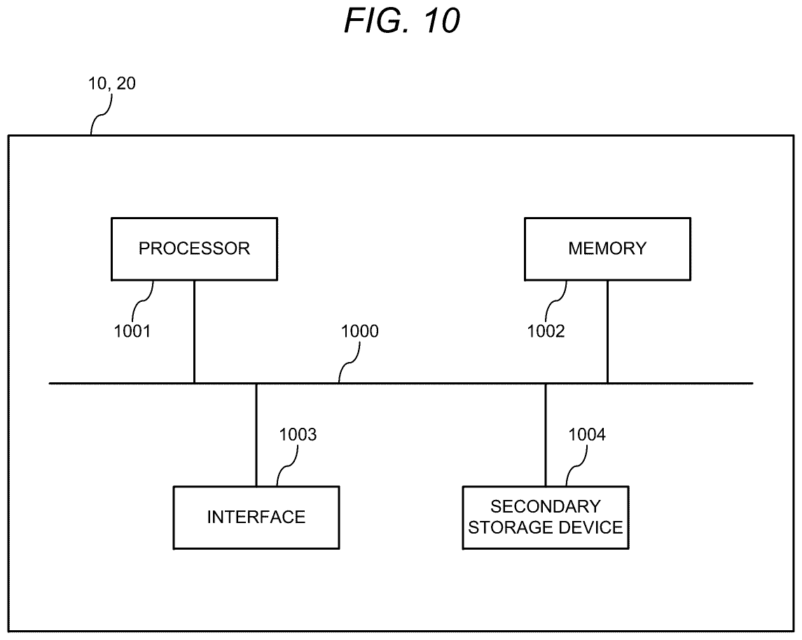

Exemplary hardware configurations of the inspection device 10 and the terminal device 20 are described with reference to FIG. 10. The inspection device 10 and the terminal device 20 illustrated in FIG. 10 are implemented by, for example, a computer such as a personal computer or a microcontroller.

The inspection device 10 and the terminal device 20 each include a processor 1001, a memory 1002, an interface 1003, and a secondary storage device 1004 that are connected to each other with a bus 1000.

The processor 1001 is, for example, a central processing unit (CPU). Each of functions of the inspection device 10 and the terminal device 20 is implemented by the processor 1001 that loads an operation program stored in the secondary storage device 1004 into the memory 1002 and executes the operation program.

The memory 1002 is a main storage device including, for example, a random-access memory (RAM). The memory 1002 stores the operation program loaded by the processor 1001 from the secondary storage device 1004. The memory 1002 functions as a working memory when the processor 1001 executes the operation program.

The interface 1003 is an input-output (I/O) interface, such as a serial port, a universal serial bus (USB) port, or a network interface.

The secondary storage device 1004 is, for example, a flash memory, a hard disk drive (HDD), or a solid-state drive (SSD). The secondary storage device 1004 stores the operation program to be executed by the processor 1001.

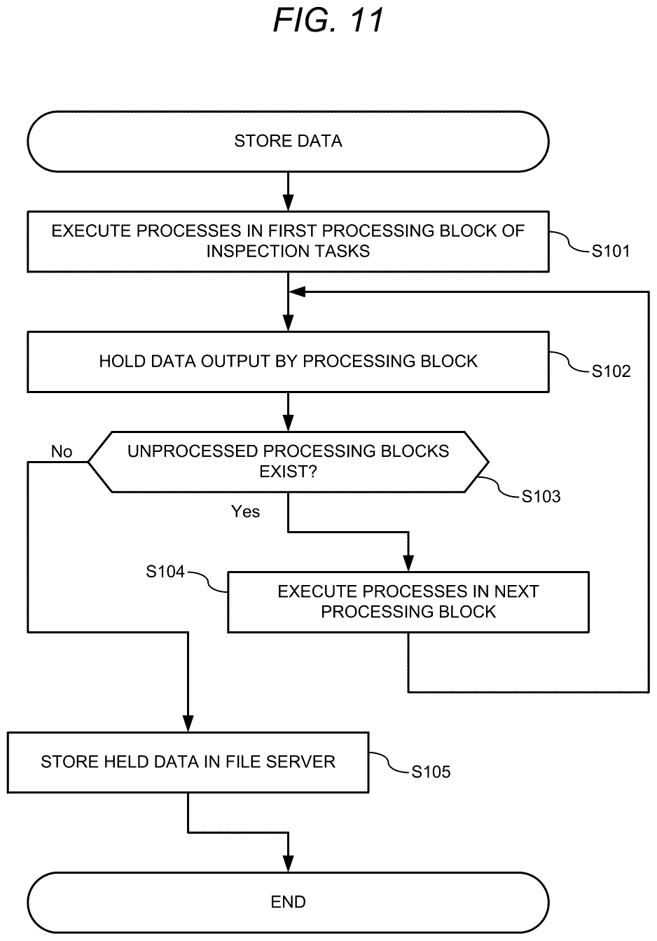

Exemplary data storage operations performed by the inspection device 10 are described with reference to FIG. 11. The operations illustrated in FIG. 11 are executed for each of the inspection tasks.

The task executer 143 of the task manager 14 of the inspection device 10 refers to the task setting information stored in the storage 13, and executes processes in the first processing block of the inspection tasks (step S101).

The task executer 143 holds data output by the processing block (step S102). Since the operations illustrated in FIG. 11 are executed for each of the inspection tasks, the data output by each of the processing blocks is held for each of the inspection tasks.

The task executer 143 determines whether there are unprocessed processing blocks (step S103). However, the unprocessed processing blocks herein do not include an operation block that is independent of the flow, such as the pausing block B6 illustrated in FIG. 3.

When there are unprocessed processing blocks (Yes in step S103), the task executer 143 executes processes in the next processing block (step S104), and repeats the operations from step S102.

When there are no unprocessed processing blocks (No in step S103), the data storage 144 of the task manager 14 stores, in the file server 40, the data held by the task executer 143 in step S102 (step S105). The task manager 14 then ends the data storage operations.

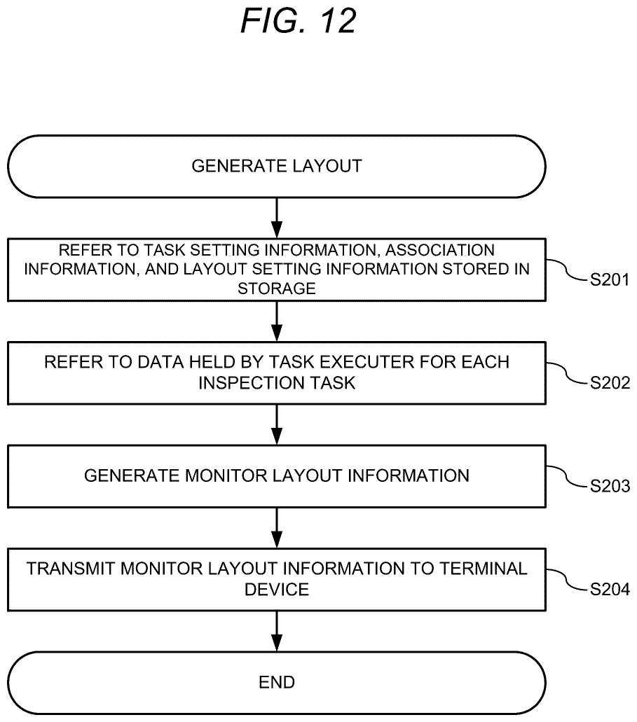

Exemplary layout generation operations performed by the inspection device 10 are described with reference to FIG. 12. The operations illustrated in FIG. 12 starts when, for example, the user operates the terminal device 20 to call the monitor screen and the operation acquirer 153 of the layout manager 15 of the inspection device 10 acquires information of this operation.

The layout generator 151 of the layout manager 15 of the inspection device 10 refers to the task setting information, the association information, and the layout setting information stored in the storage 13 (step S201).

The layout generator 151 refers to, based on the task setting information referred to in step S201, the data held by the task executer 143 for each of the inspection tasks (step S202).

The layout generator 151 generates the monitor layout information based on the task setting information, the association information, and the layout setting information referred to in the step S201 and the data held for each of the inspection tasks referred to in step S202 (step S203). As a result, the layout of the monitor screen that includes the monitor components C displaying the data output by the processing blocks B is generated.

The layout transmitter 152 of the layout manager 15 transmits, to the terminal device 20, the monitor layout information generated in step S203 (step S204). The layout manager 15 then ends the layout generation operations.

The inspection system 1 according to the embodiment is described above. The inspection system 1 allows the data storage 144 of the inspection device 10 to automatically store the data obtained in execution of the processing blocks B of the inspection tasks for each of the inspection tasks, and thus facilitates association of various types of data related to inspection. The inspection system 1 also allows the user to select data to be stored for each of the inspection tasks, and thus enables extraction and storage of the data as desired.

The inspection system 1 enables generation of the monitor layout information of the suitable monitor screen in accordance with the settings of the inspection tasks solely by configuring the settings of the inspection tasks in the task setting screen, and thus allows the user to easily review the inspection conditions. Since the inspection system 1 enables generation of the monitor layout information of the suitable monitor screen and facilitates selection of the display items, the user can easily generate the monitor screen suitable for the preferences. This allows the user to easily select processes that the user intends to review and review these processes.

The inspection system 1 also allows the user to reduce the number of the monitor components to be displayed on the monitor screen as appropriate, and thus improves the processing speed and reduces the communication load.

The inspection system 1 also allows the user to configure settings related to learning of the learning device 30, the settings of the PLC 2, the settings of the camera 3, and the settings of the light 4 through the same user interface by operating the terminal device 20, and thus reduces the workload of the user when configuring the settings of the inspection system 1.

### Modified Examples

The inspection system 1 includes both the file server 40 and the cloud system 50 in the embodiment, but may include solely one of the file server 40 and the cloud system 50. For example, the templates, frameworks, libraries, and other related resources may be provided by the file server 40, and the data for each of the inspection tasks may be stored in the cloud system 50.

The inspection device 10 and the learning device 30 are separate devices in the embodiment, but may be combined in one device. In particular, when real-time machine learning is also performed in parallel with inspection, combining the inspection device 10 and the learning device 30 in one device is likely to be more efficient.

Although the terminal device 20 and the inspection device 10 are separate devices in the embodiment, the inspection device 10 may have the functions of the terminal device 20 and function as the terminal device 20. In this case, the inspection device 10 functions as, for example, both a Web application server and a Web browser. When a user configures the settings of the PLC 2, the camera 3, and the light 4 using the inspection device 10, the function of the Web application server generates Web content indicating the setting screen, and the function of the Web browser acquires the generated Web content and displays various setting screens based on the acquired Web content.

Although the inspection device 10 includes the layout manager 15 and the storage 13 storing the task setting information, the association information, and the layout setting information in the embodiment, the terminal device 20 may include these components. In this case, the terminal device 20 generates the monitor layout information. The inspection device 10 or the terminal device 20 that generates the monitor layout information may be referred to as a display control device.

Although the inspection device 10 and the terminal device 20 each include the secondary storage device 1004 in the hardware configuration illustrated in FIG. 10, but the hardware configurations are not limited thereto. A configuration may be provided in which the secondary storage device 1004 is disposed external to the inspection device 10 or the terminal device 20, and the inspection device 10 or the terminal device 20 is connected to the secondary storage device 1004 via the interface 1003. In this configuration, a removable medium, such as a USB flash drive or a memory card, may also serve as the secondary storage device 1004.

In place of the hardware configurations illustrated in FIG. 10, the inspection device 10 and the terminal device 20 may each include a dedicated circuit with an application-specific integrated circuit (ASIC) or a field-programmable gate array (FPGA). In the hardware configurations illustrated in FIG. 10, some of the functions of the inspection device 10 and the terminal device 20 may be implemented by, for example, a dedicated circuit connected to the interface 1003.

The programs used by the inspection device 10 and the terminal device 20 may be stored in a computer-readable recording medium, such as a compact disc read-only memory (CD-ROM), a digital versatile disc (DVD), a USB flash drive, a memory card, or an HDD, and may then be distributed. A specific computer or a general-purpose computer on which the programs are installed can function as the inspection device 10 or the terminal device 20.

The above-described programs may be stored in a storage device in another server on the Internet and be downloaded from this server.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### REFERENCE SIGNS LIST

1 Inspection system
2 PLC
3 Camera
4 Light
10 Inspection device
11 First communicator
12 Second communicator
13 Storage
14 Task manager
15 Layout manager
20 Terminal device
21 Communicator
22 Display
23 Input unit
24 Controller
30 Learning device
40 File server
50 Cloud system
141 Data acquirer
142 Task setter
143 Task executer
144 Data storage
151 Layout generator
152 Layout transmitter
153 Operation acquirer
1000 Bus
1001 Processor
1002 Memory
1003 Interface
1004 Secondary storage device
B1 to B6 Processing block
C1 to C5 Monitor component
FN Factory network
IN Information network
P Production site
R Display item setting region
W Workpiece

1. An inspection device comprising:
processing circuitry to
configure a setting of an inspection task including a plurality of processing blocks, each of the plurality of processing blocks indicating a process related to inspection,
sequentially execute the plurality of processing blocks,
hold, for each set inspection task, some or all of data output by each processing block of the plurality of processing blocks and task setting information indicating the configured setting of the inspection task, and
store, in a storage for each inspection task, the data held for each inspection task.

2. The inspection device according to claim 1, wherein
the processing block is related to a process including output of data.

3. The inspection device according to claim 1, wherein
the processing circuitry further acquires data from a device related to the inspection, and
the processing block includes a processing block related to processing of the data acquired by the processing circuitry.

4. The inspection device according to claim 3, wherein
the processing circuitry acquires a device value from a programmable logic controller and acquires captured image data from an imaging device to capture an image of an inspection target to be inspected in the inspection, the captured image data being data of the captured image of the inspection target.

5. (canceled)

6. The inspection device according to claim 1, wherein
the processing circuitry selects, based on user operation, data to be stored from the data output by each of the plurality of processing blocks, and
the processing circuitry holds the data to be stored selected from the data output by each of the plurality of processing blocks.

7. An inspection system comprising:
the inspection device according to claim 1; and
a terminal device, wherein
the terminal device includes an input unit for receiving user operation, and
the processing circuitry of the inspection device configures the setting of the inspection task based on the user operation received by the input unit of the terminal device.

8. An inspection method comprising:
configuring a setting of an inspection task including a plurality of processing blocks, each of the plurality of processing blocks indicating a process related to inspection;
sequentially executing the plurality of processing blocks;
holding, for each set inspection task, some or all of data output by each processing block of the plurality of processing blocks and task setting information indicating the configured setting of the inspection task; and
storing, in a storage for each inspection task, the data held for each inspection task.

9. A non-transitory computer-readable recording medium storing a program, the program causing a computer to perform operations comprising:
configuring s setting of an inspection task including a plurality of processing blocks, each of the plurality of processing blocks indicating processing related to inspection;
sequentially executing the plurality of processing blocks;
holding, for each set inspection task, some or all of data output by each processing block of the plurality of processing blocks and task setting information indicating the configured setting of the inspection task; and
storing, in a storage for each inspection task, the data held for each inspection task.
